(19) United States
(12) Patent Application Publication
(10) Pub. No.: US 2012/0152018 A1
(43) Pub. Date: Jun. 21, 2012

(54) ATMOSPHERIC PRESSURE ESTIMATION METHOD AND ATMOSPHERIC PRESSURE ESTIMATION DEVICE

(75) Inventors: Akira Kudo, Matsumoto-shi (JP); Chen Qian, Shiojiri-shi (JP)

(73) Assignee: SEIKO EPSON CORPORATION, Shinjuku-ku (JP)

(21) Appl. No.: 13/329,159

(22) Filed: Dec. 16, 2011

(30) Foreign Application Priority Data
Dec. 17, 2010 (JP) 2010-281339
Sep. 7, 2011 (JP) 2011-194655

(51) Int. Cl. G01L 7/20

(52) U.S. Cl. 73/384

(57) ABSTRACT

An atmospheric pressure estimation method is disclosed. The method includes: controlling an oscillation frequency of a predetermined oscillator to match an oscillation frequency of an atmospheric pressure measurement oscillator; detecting a phase difference between an oscillation signal of the predetermined oscillator and an oscillation signal of the atmospheric pressure measurement oscillator; and estimating atmospheric pressure using the oscillation frequency of the predetermined oscillator and the phase difference.

This application claims priority to Japanese Patent Application No. 2010-281339, filed Dec. 17, 2010 and Japanese Patent Application No. 2011-194655, filed Sep. 7, 2011, the entirety of which are hereby incorporated by reference.

### BACKGROUND

1. Technical Field

The present invention relates to an atmospheric pressure estimation method and an atmospheric pressure estimation device.

2. Related Art

As a sensor which measures atmospheric pressure, an atmospheric pressure sensor using a quartz crystal resonator (quartz crystal resonator type atmospheric pressure sensor) has been proposed. This quartz crystal resonator type atmospheric pressure sensor estimates atmospheric pressure using the phenomenon that oscillation frequency of the quartz crystal resonator (oscillator) is changed according to pressure (for example, refer to JP-A-2010-197379).

In a case where atmospheric pressure is estimated using the oscillator of which the oscillation frequency is changed according to pressure, it is necessary to correctly measure the oscillation frequency of the oscillator. However, in order to correctly measure the oscillation frequency, it is necessary to prepare a mechanism for measuring the frequency with high accuracy, such as a clock with high accuracy or an internal time base.

### SUMMARY

An advantage of some aspect of the invention is that it provides a new atmospheric pressure estimation method using an atmospheric pressure measurement oscillator.

A first aspect of the invention is directed to an atmospheric pressure estimation method including: controlling an oscillation frequency of a predetermined oscillator to match the oscillation frequency of the predetermined oscillator to an oscillation frequency of an atmospheric pressure measurement oscillator; detecting a phase difference between an oscillation signal of the predetermined oscillator and an oscillation signal of the atmospheric pressure measurement oscillator; and estimating atmospheric pressure using the oscillation frequency of the predetermined oscillator and the phase difference.

As another aspect of the invention, there may be provided an atmospheric pressure estimation device including: an atmospheric pressure measurement oscillator the oscillation frequency of which is changed according to atmospheric pressure; an oscillator of which oscillation frequency can be changed; a frequency control section which controls the oscillation frequency of the oscillator to match the oscillation frequency of the predetermined oscillator to the oscillation frequency of the atmospheric pressure measurement oscillator; a phase difference detecting section which detects a phase difference between an oscillation signal of the oscillator and an oscillation signal of the atmospheric pressure measurement oscillator; and an atmospheric pressure estimating section which estimates atmospheric pressure using the oscillation frequency of the oscillator and the phase difference.

According to these configurations, the oscillation frequency of the predetermined oscillator is controlled to match the oscillation frequency of the predetermined oscillator to the oscillation frequency of the atmospheric pressure measurement oscillator. Further, the phase difference between the oscillation signals of the oscillators is detected, and the atmospheric pressure is estimated using the oscillation frequency of the predetermined oscillator and the phase difference. Accordingly, it is possible to estimate the atmospheric pressure without directly and correctly measuring the oscillation frequency of the atmospheric pressure measurement oscillator.

As a second aspect of the invention, the atmospheric pressure estimation method according to the first aspect of the invention may be configured such that the controlling includes controlling the oscillation frequency of the predetermined oscillator on the basis of the phase difference.

According to the second aspect of the invention, for example, it is possible to appropriately control the oscillation frequency of the oscillator using a phase synchronization technique based on the phase difference between the oscillation signal of the oscillator and the oscillation signal of the atmospheric pressure measurement oscillator.

As a third aspect of the invention, the atmospheric pressure estimation method according to the first or second aspect of the invention may be configured such that the detecting includes detecting the phase difference using a Costas loop.

According to the third aspect of the invention, it is possible to simply detect the phase difference using the Costas loop.

As a fourth aspect of the invention, the atmospheric pressure estimation method according to any of the first to third aspects of the invention may be configured such that the estimating includes: estimating the atmospheric pressure at a first resolution using the oscillation frequency of the predetermined oscillator; and estimating the atmospheric pressure corresponding to 1 Hz or less of the predetermined oscillator at a second resolution higher than the first resolution, using the phase difference.

According to the fourth aspect of the invention, the atmospheric pressure is estimated at the first resolution using the oscillation frequency of the predetermined oscillator, and the atmospheric pressure corresponding to 1 Hz or less of the oscillator is estimated at the second resolution higher than the first resolution using the detected phase difference. Accordingly, it is possible to realize the atmospheric pressure estimation with high accuracy.

As a fifth aspect of the invention, the atmospheric pressure estimation method according to any of the first to fourth aspects of the invention may be configured such that the estimating includes estimating the atmospheric pressure using the phase difference detected for a predetermined time, and the method further includes determining stability of the oscillation frequency of the atmospheric pressure measurement oscillator and setting the predetermined time on the basis of the stability.

According to the fifth aspect of the invention, the atmospheric pressure is estimated using the phase difference detected for the predetermined time. Further, the stability of the oscillation frequency of the atmospheric pressure measurement oscillator is determined, and the predetermined time is set on the basis of the stability. By setting, as the predetermined time, the time when the stability of the oscillation frequency of the atmospheric pressure measurement oscillator becomes high, it is possible to optimize an atmospheric pressure estimation timing.

As a sixth aspect of the invention, the atmospheric pressure estimation method according to the fifth aspect of the invention may be configured such that the determining includes calculating an Allan variance of the oscillation frequency of the atmospheric pressure measurement oscillator.

According to the sixth aspect of the invention, by calculating the Allan variance of the oscillation frequency of the atmospheric pressure measurement oscillator, it is possible to appropriately determine the stability of the oscillation frequency of the atmospheric pressure measurement oscillator.

As a seventh aspect of the invention, the atmospheric pressure estimation method according to any of the first to sixth aspects of the invention may be configured such that the estimating includes temperature-compensating the atmospheric pressure on the basis of an environmental temperature.

According to the seventh aspect of the invention, by temperature-compensating the atmospheric pressure on the basis of the environmental temperature, it is possible to appropriately perform the atmospheric pressure estimation regardless of the environmental temperature.

### BRIEF DESCRIPTION OF THE DRAWINGS

The invention will be described with reference to the accompanying drawings, wherein like numbers reference like elements.

FIG. 1 is a diagram illustrating an example of a functional configuration of a quartz crystal resonator type atmospheric pressure sensor.

FIG. 2 is a diagram illustrating a principle of atmospheric pressure estimation.

FIG. 3 is a diagram illustrating a principle of estimation time interval calibration.

FIG. 4 is a diagram illustrating a principle of estimation time interval calibration.

FIG. 5 is a flowchart illustrating the flow of a procedure of an atmospheric pressure estimation process.

FIG. 6 is a flowchart illustrating the flow of a procedure of an estimation time interval calibration process.

FIG. 7 is a diagram illustrating an example of a functional configuration of a GPS position calculating device.

### DESCRIPTION OF EXEMPLARY EMBODIMENTS

Hereinafter, an example of a preferred embodiment of the invention will be described with reference to the accompanying drawings. The present embodiment is an embodiment of a quartz crystal resonator type atmospheric pressure sensor which includes an atmospheric pressure estimating device. Here, the embodiment to which the invention is applied is not limited to the embodiment to be described below.

### 1. Functional Configuration

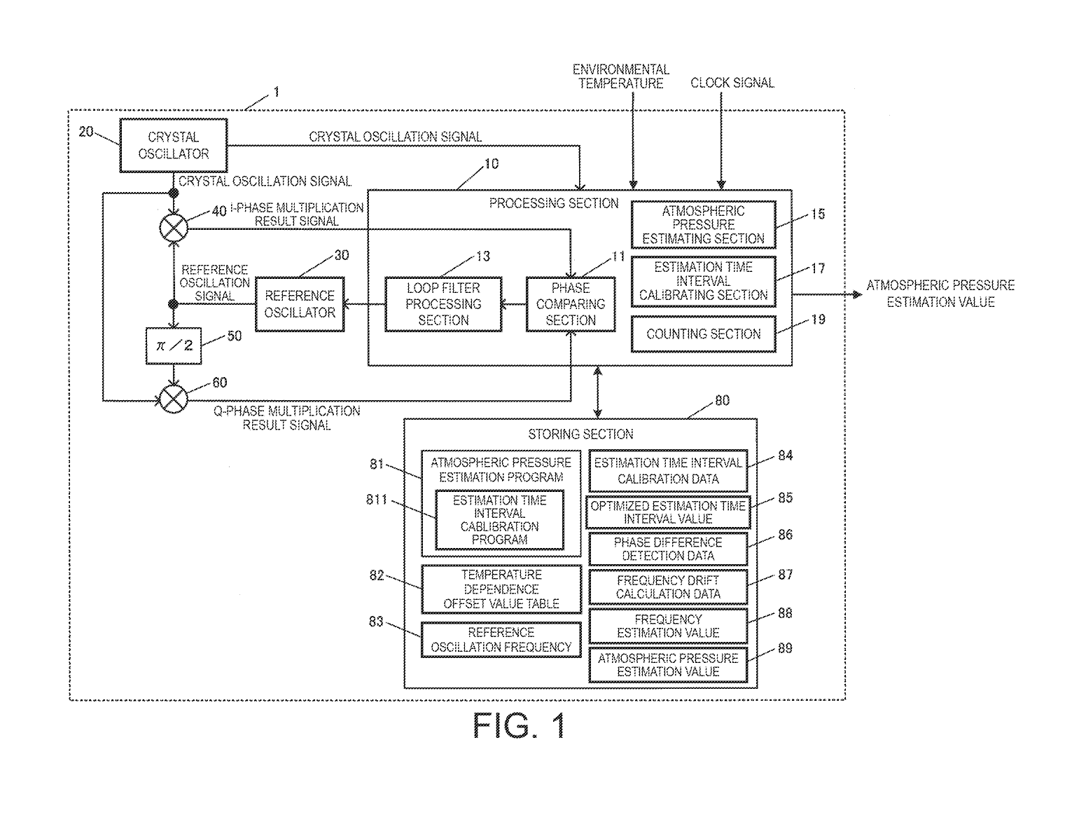

FIG. 1 is a diagram illustrating an example of a functional configuration of a quartz crystal resonator type atmospheric pressure sensor 1 according to the present embodiment. The quartz crystal resonator type atmospheric pressure sensor 1 includes a processing section 10, a crystal oscillator 20, a reference oscillator 30, a first multiplier 40, a delay circuit 50, a second multiplier 60, and a storing section 80.

The processing section 10 includes a processor such as a CPU (Central Processing Unit) which is a control device which generally controls the respective sections of the quartz crystal resonator type atmospheric pressure sensor 1 and an arithmetic device. The processing section 10 includes a phase comparing section 11, a loop filter processing section 13, an atmospheric pressure estimating section 15, an estimation time interval calibrating section 17 and a counting section 19, as main functional sections.

A reference oscillation signal output from the reference oscillator 30 passes through the delay circuit 50 while being used as an I-phase reference oscillation signal as it is, to become a Q-phase reference oscillation signal. Further, a crystal oscillation signal output from the crystal oscillator 20 is multiplied by the I-phase and Q-phase reference oscillation signals by the first multiplier 40 and the second multiplier 60 to become an I-phase multiplication result signal and a Q-phase multiplication result signal, which are respectively input to the phase comparing section 11.

The phase comparing section 11 compares a phase of the crystal oscillation signal of the crystal oscillator 20 with a phase of the reference oscillation signal of the reference oscillator 30. Specifically, the I-phase multiplication result signal output from the first multiplier 40 is multiplied by the Q-phase multiplication result signal output from the second multiplier 60, and then the multiplication result is output to the loop filter processing section 13. The phase comparing section 11 is a functional block corresponding to a phase comparator in a PLL (Phase Locked Loop) circuit which is known as a phase synchronization circuit.

The loop filter processing section 13 performs an averaging process for the comparison result of the phase comparing section 11, and converts the comparison result into a stable value (signal). A phase difference detecting section which detects a phase difference between the reference oscillation signal of the reference oscillator 30 and the crystal oscillation signal of the crystal oscillator 20 is configured by the phase comparing section 11 and the loop filter processing section 130.

Further, an oscillation frequency of the reference oscillator 30 is controlled using the detected phase difference. Specifically, the difference between the oscillation frequency of the reference oscillator 30 and the oscillation frequency of the crystal oscillator 20 is detected as the phase difference, and the oscillation frequency of the reference oscillator 30 is controlled to match the oscillation frequency of the crystal oscillator 20. That is, the phase comparing section 11 and the loop filter processing section 13 serve as a frequency control section. In the following description, the oscillation frequency of the crystal oscillator 20 is referred to as a “crystal oscillation frequency” and the oscillation frequency of the reference oscillator 30 is referred to as a “reference oscillation frequency”.

The atmospheric pressure estimating section 15 estimates an atmospheric pressure according to an atmospheric pressure estimation program 81 stored in the storing section 80. Specifically, on the basis of the comparison result of the phase comparing section 11 or a value averaged by the loop filter processing section 13, the size of drift of the crystal oscillation frequency from the reference oscillation frequency is calculated with a predetermined accuracy of 1 Hz or less. On the basis of a temporal change, corresponding to a predetermined unit time, of the phase difference which is frequently detected, the size of the frequency drift of the crystal oscillation frequency and the reference oscillation frequency is estimated.

Further, at a predetermined estimation timing, the crystal oscillation frequency is estimated using the reference oscillation frequency and the calculated frequency drift. When the crystal oscillation frequency is estimated, the estimated value of the crystal oscillation frequency is converted to atmospheric pressure using a relational expression or a reference table which matches the crystal oscillation frequency and the atmospheric pressure.

In the present embodiment, a time interval when the frequency drift is calculated is defined as a “unit time interval”, and a time corresponding to the unit time interval is defined as a “unit time”. Further, a time interval when the crystal oscillation frequency and the atmospheric pressure are estimated is defined as an “estimation time interval”, and a time corresponding to the estimation time interval is defined as an “estimation time”. The unit time interval is “1 millisecond”, for example. In this case, frequency drift is calculated every 1 millisecond. Further, the estimation time interval is set to a time longer than the unit time interval by the estimation time interval calibrating section 17.

The estimation time interval calibrating section 17 calibrates the estimation time interval according to an estimation time interval calibration program 811 stored in the storing section 80. More specifically, the estimation time interval calibrating section 17 determines the stability of the crystal oscillation frequency using the Allan variance, and calibrates and sets the estimation time interval on the basis of the determination result.

The counting section 19 measures an initial value of the crystal oscillation frequency on the basis of a clock signal input from the outside. Specifically, at an initial setting time after electric power is supplied, the counting section 19 receives the crystal oscillation signal of the crystal oscillator 20 as an input, and measures an approximate value of the crystal oscillation frequency. The measured approximate value may be an approximate value (for example, an integer part of the frequency) of the frequency of the crystal oscillation signal. Further, the oscillation frequency of the reference oscillator 30 is initially set by the measured approximate value.

The crystal oscillator 20 is an atmospheric pressure measurement oscillator in which the oscillation frequency is changed according to atmospheric pressure, and is configured as a crystal device which is mounted with a quartz crystal resonator and a crystal oscillation circuit, for example. The quartz crystal resonator and the crystal oscillation circuit may be packaged and manufactured as one chip. As the quartz crystal resonator, for example, a double-ended tuning fork type quartz crystal resonator may be used.

The reference oscillator 30 is an oscillator for synchronization with the crystal oscillation signal, in which the reference oscillation frequency is controlled to match the crystal oscillation frequency. The reference oscillator 30 is a variable frequency oscillator in which the oscillation frequency is changeable, and includes an NCO (Numerical Controlled Oscillator), for example.

The first multiplier 40 is a multiplier which multiplies the crystal oscillation signal of the crystal oscillator 20 by the reference oscillation signal of the reference oscillator 30. By multiplication of the crystal oscillation signal and the reference oscillation signal, the signals are converted to a signal (I-phase multiplication result signal) of the frequency difference between the crystal oscillation frequency and the reference oscillation frequency. The I-phase multiplication result signal is output to the phase comparing section 11.

The delay circuit 50 is a delay circuit which temporally delays the reference oscillation signal of the reference oscillator 30 by 90° (=π/2), and outputs the delayed reference oscillation signal to the second multiplier 60 as an orthogonal reference oscillation signal.

The second multiplier 60 is a multiplier which multiplies the crystal oscillation signal of the crystal oscillator 20 by the orthogonal reference oscillation signal. By multiplication of the crystal oscillation signal and the orthogonal reference oscillation signal, the signals are converted to a signal (Q-phase multiplication result signal) of the frequency difference between the crystal oscillation frequency and the orthogonal reference oscillation frequency. The Q-phase multiplication result signal is output to the phase comparing section 11.

A Costas loop is formed by a first loop sequentially including the first multiplier 40, the phase comparing section 11, the loop filter processing section 13, the reference oscillator 30, and the first multiplier 40; and a second loop sequentially including the second multiplier 60, the phase comparing section 11, the loop filter processing section 13, the reference oscillator 30, the delay circuit 50, and the second multiplier 60. In the present embodiment, the phase difference is detected by the Costas loop.

The storing section 80 is a storing device which stores a system program with which the processing section 10 generally controls the respective sections of the quartz crystal resonator type atmospheric pressure sensor 1, or a variety of programs, data or the like with which the processing section 10 performs a variety of processes such as an atmospheric pressure estimation process or an estimation time interval calibration process. The storing section 80 includes a memory such as a ROM (Read Only Memory), a flash ROM, or a RAM (Random Access Memory).

### 2. Principle

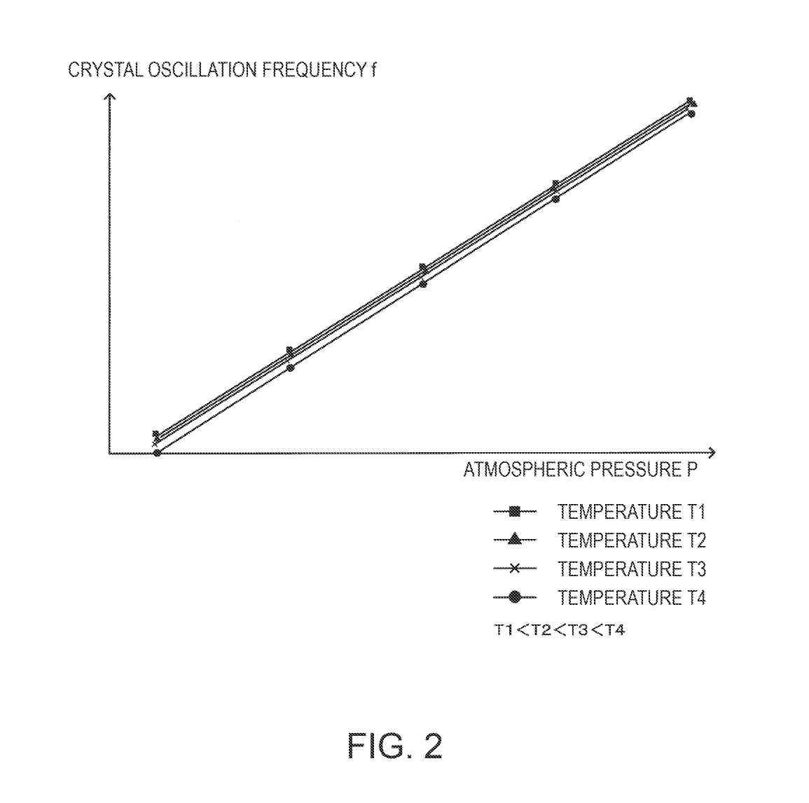

FIG. 2 is a diagram illustrating a principle of the atmospheric pressure estimation according to the present embodiment. In FIG. 2, the transverse axis represents atmospheric pressure “P”, and the longitudinal axis represents crystal oscillation frequency “f”. Further, the crystal oscillation frequencies to the atmospheric pressures at respective temperatures “T1 to T4” (T1<T2<T3<T4) are respectively plotted in a black rectangular shape, a black triangular shape, a cross shape and a black circular shape.

It can be understood from this graph that the atmospheric pressure “P” and the crystal oscillation frequency “f” form an approximately linear relationship irrespective of temperature. Further, as the temperature is increased, the total size of the crystal oscillation frequency “f” tends to be decreased. It is possible to estimate the atmospheric pressure, using an environmental temperature and an estimation value of the crystal oscillation frequency, from such a relationship of the atmospheric pressure and the crystal oscillation frequency.

The processing section 10 calculates “drift” of the crystal oscillation frequency from the reference oscillation frequency due to change in an operational condition or the like, on the basis of temporal change, corresponding to the unit time, of a phase difference “Δθ” detected using the Costas loop. The drift of “Δf” of the crystal oscillation frequency from the reference oscillation frequency is defined as “frequency drift”. Further, a value “Δf/f_{b}” obtained by dividing the frequency drift “Δf” by the reference oscillation frequency “f_{b}” is defined as “frequency deviation”.

The relationship of the following expression (1) is established between the phase difference “Δθ” and the frequency drift “Δf”.

$$Δ f ( t ) = \frac{1}{2 π} \frac{d Δθ ( t )}{d t} \qquad ( 1 )$$

The temporal change of the phase difference “Δθ” corresponding to one cycle (360°) is calculated as the frequency drift “Δf” of “1 [Hz]”, from the expression (1). Further, the frequency drift “Δf” is calculated from the amount of temporal change “dΔθ/dt” of the phase difference “Δθ” corresponding to the unit time. The calculation of the frequency drift “Δf” is performed for every unit time. Further, whenever a predetermined estimation time elapses, the crystal oscillation frequency “f” is estimated using the frequency drift “Δf” calculated during the corresponding estimation time.

For example, if the unit time is “1 millisecond” and the estimation time is “10 milliseconds”, calculation data of ten frequency drifts “Δf” is obtained until an estimation timing comes. For example, the crystal oscillation frequency “f” is estimated using a maximum value, a median value or an average value of the frequency drift “Δf” as a representative value, among these calculation data. That is, a value obtained by adding the representative value of the frequency drift “Δf” to a reference oscillation frequency “f_{b}” is estimated as the crystal oscillation frequency “f” (f=f_{b}+Δf). When the crystal oscillation frequency “f” is estimated, the atmospheric pressure is estimated from the relationship of the atmospheric pressure and the crystal oscillation frequency in FIG. 2.

In a case where the atmospheric pressure is estimated using the reference oscillation frequency “f_{b}”, the value of the atmospheric pressure is calculated only approximately. However, as described above, as the frequency drift “Δf” of 1 Hz or less is calculated using the phase difference “Δθ” and the atmospheric pressure is estimated considering the frequency drift “Δf”, it is possible to estimate the atmospheric pressure at high resolution. That is, according to the present embodiment, the atmospheric pressure is estimated at a first resolution using the reference oscillation frequency “f_{b}”, and the atmospheric pressure corresponding to 1 Hz or less of the reference oscillator 30 is estimated at a second resolution which is higher than the first resolution using the phase difference “Δθ”.

According to experiments carried out by the present applicants, the frequency drift “Δf” in a case where the phase difference “Δθ” is changed by one cycle (360°) is about 57 pascals [Pa]. Accordingly, if the phase difference “Δθ” is changed by 1°, the frequency drift “Δf” becomes about 0.16 [Pa]. When an atmospheric pressure change of 1000 [Pa] is converted into an altitude change of 100 [m], a change of 1° of the phase difference “Δθ” corresponds to an altitude change of about 1.6 [cm]. If the change in the phase difference “Δθ” is calculated in the unit of 30° in consideration of errors, it is possible to detect an altitude change of about 48 [cm]. Thus, it can be understood that it is possible to realize atmospheric pressure estimation with high accuracy using the frequency drift of 1 Hz or less in the atmospheric pressure estimation method according to the present embodiment.

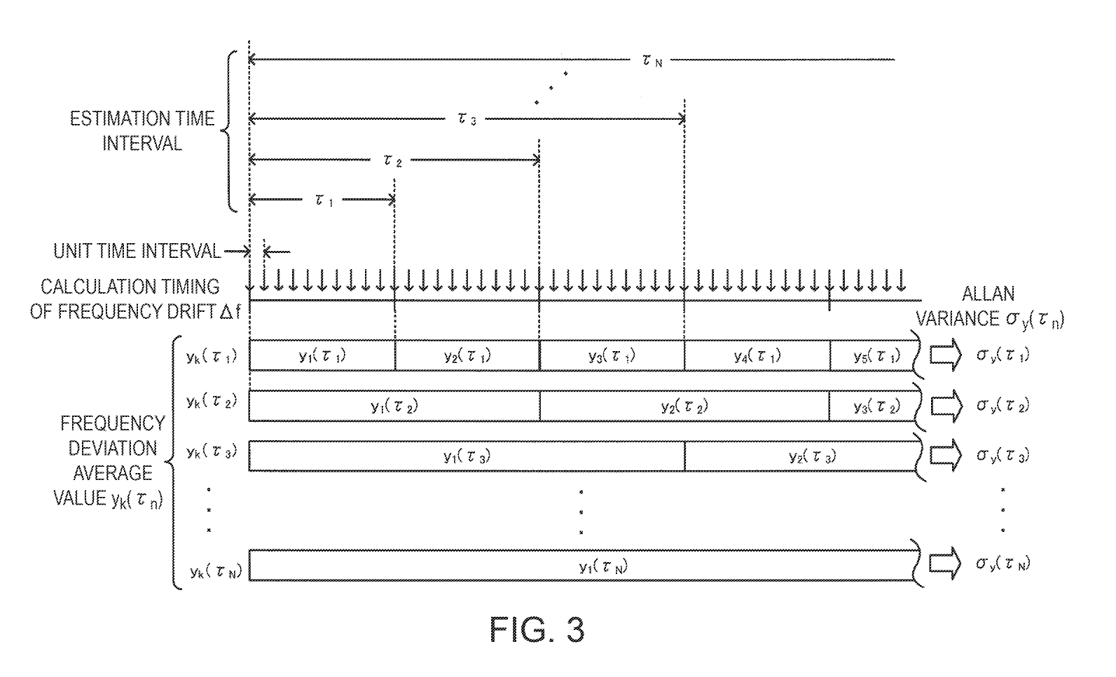

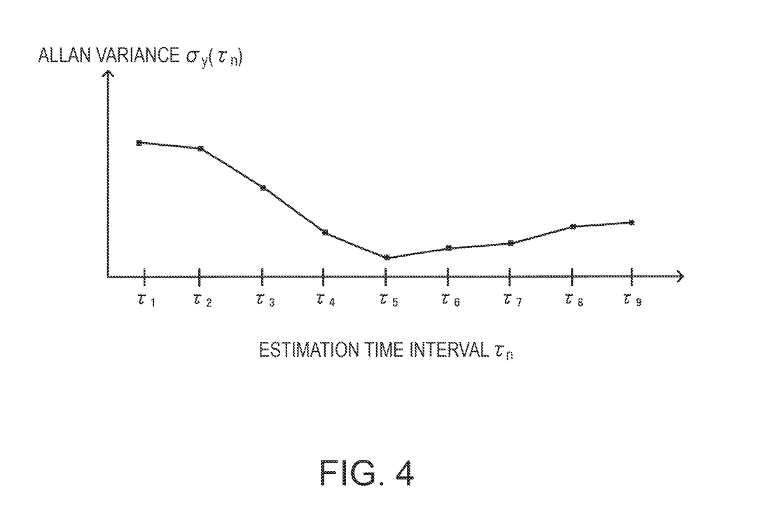

FIGS. 3 and 4 are diagrams illustrating a principle of the estimation time interval calibration according to the present embodiment. In the present embodiment, the stability (frequency stability) of the crystal oscillation frequency is determined, and the estimation time interval is calibrated on the basis of the frequency stability. The determination of the frequency stability is performed by calculating the Allan variance of the crystal oscillation frequency.

The Allan variance is an index value indicating how long a specific oscillator is able to oscillate a signal having a stable frequency. It can be said that the Allan variance is a criterion of the frequency stability in a time area. The Allan variance is defined as a two-sample variance in which the frequency deviations are averaged for a predetermined averaging time and the variation is calculated using two samples.

Firstly, the frequency deviation “y(t)” is defined by the following expression (2).

$$y ( t ) = \frac{Δ f ( t )}{{f}_{b}} \qquad ( 2 )$$

Here, the frequency drift “Δf(t)” is time-series data calculated at the unit time interval, which is expressed as a time function.

Here, the estimation time interval is expressed as “τ”. At this time, a frequency deviation average value “yₖ(τₙ)” is calculated by averaging the frequency deviations “y(t)” for each section of a certain estimation time interval “τₙ”. The estimation time interval “τ” corresponds to an averaging time when the frequency deviations “y(t)” are averaged.

Specifically, the frequency deviation average value “yₖ(τₙ)” is calculated according to the following expression (3).

$${y}_{k} ( {τ}_{n} ) = \frac{1}{τ} {\int }_{{t}_{k}}^{{t}_{k} + {τ}_{n}} y ( t ) d t \\ provided that {t}_{k} = k τ \qquad ( 3 )$$

Here, the suffix “k” represents the number of the frequency deviation average value, and the “yₖ(τₙ)” represents a k-th value among the frequency deviation average values averaged for each section of the estimation time interval “τₙ”.

At this time, the Allan variance “σ_{y}(τₙ)” of the crystal oscillation frequency “f” at the estimation time interval “τₙ” is calculated according to the following expression (4).

$${σ}_{y} ( {τ}_{n} ) = \sqrt{\frac{1}{2} {\sum }_{k} {( {y}_{k + 1} ( {τ}_{n} ) - {y}_{k} ( {τ}_{n} ) )}^{2}} \qquad ( 4 )$$

The “σ_{y}(τₙ)” is exactly the Allan standard deviation, but the Allan standard deviation is used as the same meaning as the Allan variance, in the present description.

The Allan variance “τ_{y}(τₙ)” is calculated while changing the estimation time interval “τₙ”. For example, as shown in FIG. 3, N types of estimation time intervals “τₙ={τ₁, τ₂, τ₃, . . . , τ_{N}} are set. In FIG. 3, the transverse axis represents a time axis, and downward arrows in the uppermost line represent calculation timings of the frequency drift “Δf”. Further, transverse bands in the second line and below represent data about the frequency deviation average value “yₖ(τₙ)” at each estimation time interval “τₙ”, in which one block corresponds to one piece of data. The estimation time interval “τₙ” is set as a discrete value included in the time range from 10 milliseconds to 100 milliseconds, for example.

FIG. 4 is an example of a graph illustrating a correspondence relationship between the estimation time interval and the Allan variance. The transverse axis represents the estimation time interval “τₙ”, and the longitudinal axis represents the Allan variance “σ_{y}(τₙ)”. It can be understood from this graph that the Allan variance “σ_{y}(τᵢₐ)” is gradually decreased as the estimation time interval “τₙ” is increased. Further, it can be understood that the Allan variance “σ_{y}(τₙ)” becomes a minimum value at a certain estimation time interval and then tends to be increased again.

The Allan variance “σ_{y}(τₙ)” is a value indicating the margin of error of the crystal oscillation frequency in the period corresponding to the estimation time interval “τₙ”. Thus, it can be said that as the Allan variance “σ_{y}(τₙ)” is small, the crystal oscillation frequency “f” is stable.

For example, in the graph of FIG. 4, the Allan variance “σ_{y}(τ₅)” at the estimation time interval “τ₅” is the minimum. That is, the crystal oscillation frequency is most stabilized at the estimation time interval “τ₅”. Further, it can be determined that if it corresponds to the estimation time interval “τ₅”, an error of the crystal oscillation frequency “f” may be decreased without limit. Thus, in the present embodiment, the estimation time interval when the Allan variance “σ_{y}(τₙ)” is the minimum is set as an appropriate value of the estimation time interval. Accordingly, it is possible to optimize the estimation of the atmospheric pressure timing.

### 3. Configuration of Data

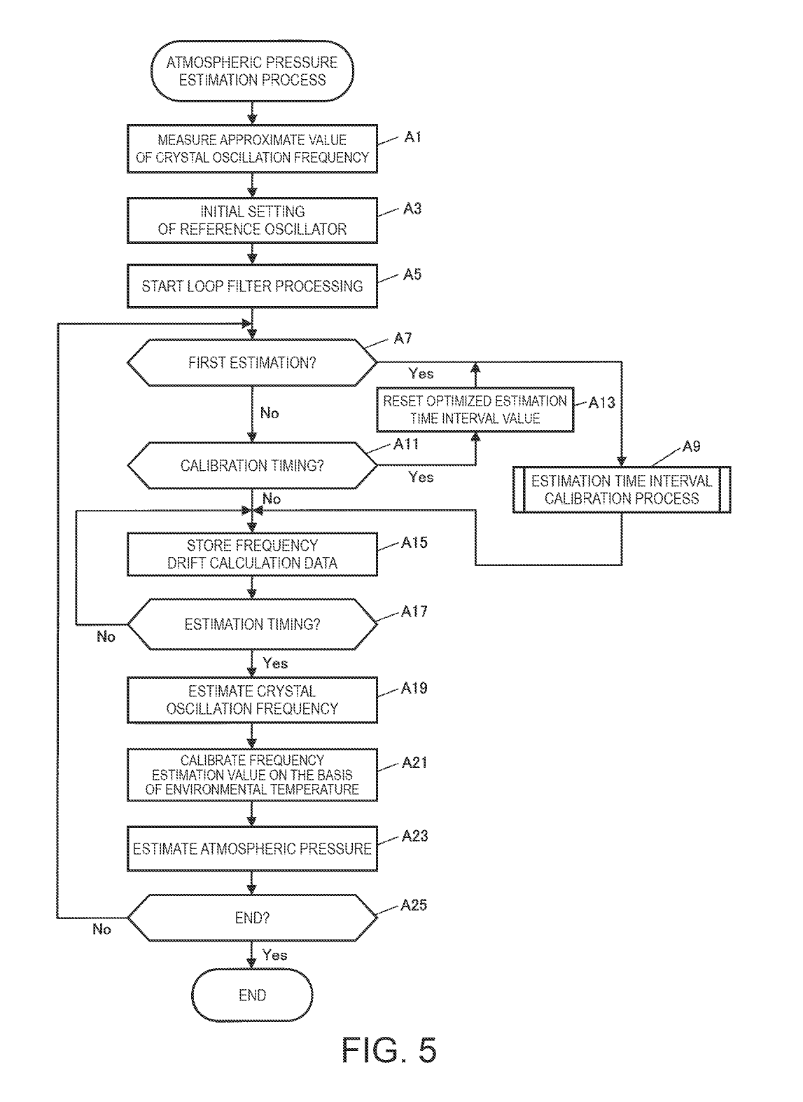

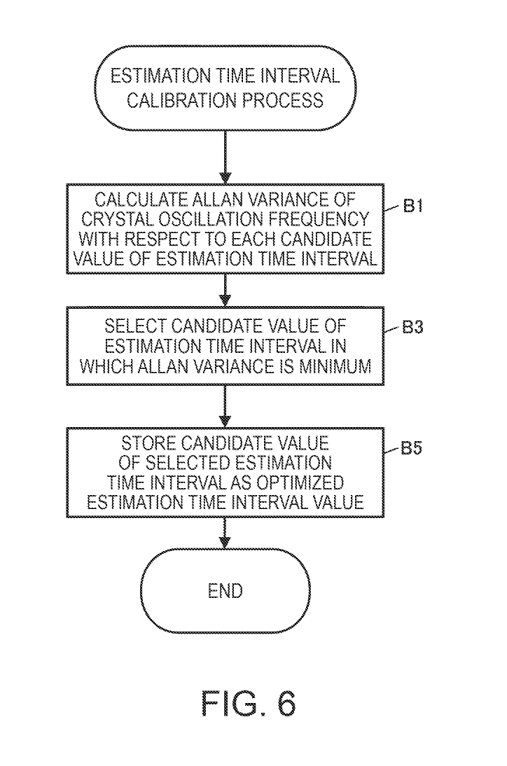

As shown in FIG. 1, the atmospheric pressure estimation program 81 which is read by the processing section 10 and is executed in the atmospheric pressure estimation process (see FIG. 5) is stored in the storing section 80. Further, the atmospheric pressure estimation program 81 includes the estimation time interval calibration program 811 which is executed in the estimation time interval calibration process (see FIG. 6) as a sub-routine. These processes will be described later in detail with reference to flowcharts.

Further, a temperature dependence offset value table 82, a reference oscillation frequency 83, an estimation time interval calibration data 84, an optimized estimation time interval value 85, a phase difference detection data 86, a frequency drift calculation data 87, a frequency estimation value 88, and an atmospheric pressure estimation value 89 are stored in the storing section 80.

The temperature dependence offset value table 82 is a table in which the offset value of the crystal oscillation frequency is stored to match the temperature. The temperature dependence offset value table 82 is used for temperature-compensating the atmospheric pressure on the basis of an environmental temperature.

The reference oscillation frequency 83 is the oscillation frequency of the reference oscillator 30. At the initial setting time after electric power is supplied, an approximate value of the crystal oscillation frequency is measured, and is initially set as the reference oscillation frequency 83. Thereafter, the reference oscillation frequency is controlled so that the phase difference is removed by a loop filter process, and the reference oscillation frequency 83 is frequently updated.

The estimation time interval calibration data 84 is data used for calibration of the estimation time interval. The data on the frequency deviation, the frequency deviation average value and the Allan variance of the crystal oscillation frequency, as described in the principle, is included in the estimation time interval calibration data 84.

The optimized estimation time interval value 85 is data of optimized values of the estimation time interval. Whenever the estimation time interval calibration process is performed, the optimized estimation time interval value 85 is set and updated.

The phase difference detection data 86 is data of phase differences which are frequently detected by the loop filter process. Further, the frequency drift calculation data 87 is data about frequency drifts calculated at the unit time interval.

### 4. Procedure of Processes

FIG. 5 is a flowchart illustrating a flow of a procedure of the atmospheric pressure estimation process performed in the quartz crystal resonator type atmospheric pressure sensor 1 as the atmospheric pressure estimation program 81 stored in the storing section 80 is read by the processing section 10 to be executed.

Firstly, the counting section 19 measures an approximate value of the crystal oscillation frequency (step A1). That is, an integer part of frequency of a crystal oscillation signal output from the crystal oscillator 20 is measured on the basis of a predetermined clock signal. Further, the reference oscillator 30 is initially set using the measured approximate value as the reference oscillation frequency 83 (step A3).

Then, the loop filter processing section 13 starts the loop filter process, and frequently stores the detected phase difference as the phase difference detection data 86 in the storing section 80 (step A5). Further, the processing section 10 determines whether the first estimation is performed after electric power is supplied (step A7). In a case where it is determined that the first estimation is performed (Yes in step A7), the processing section 10 performs the estimation time interval calibration process according to the estimation time interval calibration program 811 stored in the storing section 80 (step A9).

FIG. 6 is a flowchart illustrating a flow of a procedure of the estimation time interval calibration process.

Firstly, the estimation time interval calibrating section 17 calculates the Allan variance of the crystal oscillation frequency with respect to each of a plurality of candidate values of the estimation time interval (step B1).

Then, the estimation time interval calibrating section 17 selects a candidate value of the estimation time interval in which the Allan variance calculated in step B1 is the minimum (step B3). Further, the estimation time interval calibrating section 17 stores the selected candidate value as the optimized estimation time interval value 85 in the storing section 80 (step B5), and then, the estimation time interval calibration process is ended.

Returning to the atmospheric pressure estimation process of FIG. 5, in a case where it is determined in step A7 that the estimation is not the first estimation (No in step A7), the atmospheric pressure estimating section 15 determines whether it is the calibration timing of the estimation time interval (step A11). As the calibration timing, a variety of timings may be set. For example, a timing when a predetermined time elapses may be used, or a timing when the environmental temperature is changed to a predetermined temperature or more may be used. Further, a timing when calibration is instructed by a user may be used.

In a case where it is determined that it is the calibration timing (Yes in step A11), the atmospheric pressure estimating section 15 resets the optimized estimation time interval value 85 stored in the storing section 80 (step A13). Further, the procedure goes to step A9, and the estimation time interval calibrating section 17 performs the estimation time interval calibration process again.

After the estimation time interval calibration process is performed in step A9, or in a case where it is determined in step A11 that it is not the calibration timing (No in step A11), the atmospheric pressure estimating section 15 calculates the frequency drift on the basis of temporal change, corresponding to the unit time, of the phase difference which is stored in the phase difference detection data 86, and stores the result in the storing section 80 as the frequency drift calculation data 87 (step A15).

The atmospheric pressure estimating section 15 repeats the process of step A15 until the estimation timing comes (No in step A17). If the estimation timing comes (Yes in step A17), the atmospheric pressure estimating section 15 estimates the crystal oscillation frequency using the reference oscillation frequency 83 stored in the storing section 80 and the frequency drift stored in the frequency drift calculation data 87, and then stores the result in the storing section 80 as the frequency estimation value 88 (step A19).

Then, the atmospheric pressure estimating section 15 corrects the frequency estimation value 88 on the basis of the environmental temperature (step A21). Specifically, the atmospheric pressure estimating section 15 reads the offset value of the oscillation frequency corresponding to the environmental temperature obtained from a temperature sensor or the like, with reference to the temperature dependence offset value table 82 stored in the storing section 80. Further, the atmospheric pressure estimating section 15 subtracts the offset value from the frequency estimation value 88.

Thereafter, the atmospheric pressure estimating section 15 converts the frequency estimation value 88 to an atmospheric pressure, and stores the result in the storing section 80 as the atmospheric pressure estimation value 89 (step A23). Further, the atmospheric pressure estimating section 15 determines whether to terminate the process (step A25). In a case where it is determined that the process is not to be terminated (No in step A25), the procedure returns to step A7. Further, in a case where it is determined that the process is to be terminated (Yes in step A25), the atmospheric pressure estimation process is terminated.

### 5. Effects

In the quartz crystal resonator type atmospheric pressure sensor 1, the processing section 10 controls the oscillation frequency of the reference oscillator 30 to match the oscillation frequency of the atmospheric pressure measurement crystal oscillator 20. Further, the processing section 10 detects the phase difference between the oscillation signal of the reference oscillator 30 and the oscillation signal of the crystal oscillator 20, and then estimates the atmospheric pressure using the oscillation frequency of the reference oscillator 30 and the phase difference.

Specifically, the crystal oscillation signal is divided into I and Q using the reference oscillation signal, and the phase difference between the reference oscillation signal and the crystal oscillation signal is detected using the Costas loop. Further, the frequency drift is calculated on the basis of the temporal change of the phase difference corresponding to the unit time, and the frequency drift is added to the reference oscillation frequency, to thereby estimate the crystal oscillation frequency. With such a configuration, it is possible to estimate the oscillation frequency of the crystal oscillator 20, on the basis of the phase difference between the crystal oscillation signal and the reference oscillation signal without directly and correctly measuring the oscillation frequency from the oscillation signal of the crystal oscillator 20.

Further, the estimation time interval calibrating section 17 calibrates the time interval in which the estimation of the crystal oscillation frequency and the atmospheric pressure is performed at the initial estimation time and at a predetermined calibration timing. Specifically, the frequency stability of the crystal oscillator 20 is determined by calculating the Allan variance of the crystal oscillation frequency, and the time interval in which the frequency stability becomes the maximum is set as the optimized value of the estimation time interval. Thus, it is possible to estimate the atmospheric pressure at an appropriate timing based on the frequency stability.

### 6. Modification

### 6-1. Application Example

The quartz crystal resonator type atmospheric pressure sensor 1 according to the above-described embodiment may be used while being mounted on an altimeter, for example. Specifically, in the altimeter which is mounted with the quartz crystal resonator type atmospheric pressure sensor 1, a processing section converts and estimates an atmospheric pressure estimation value output from the quartz crystal resonator type atmospheric pressure sensor 1 to an altitude. Further, the estimated altitude is displayed on a display section.

### 6-2. Detection of Phase Difference

In the above-described embodiment, the phase difference between the crystal oscillation signal and the reference oscillation signal is detected by means of software as digital signal processing by the processing section. However, the detection of the phase difference may be performed by means of hardware by forming the Costas loop by a PLL circuit including a phase comparator, a loop filter and a VCO (Voltage Controlled Oscillator).

### 6-3. Estimation of Atmospheric Pressure

The estimation of the crystal oscillation frequency may be performed as follows. That is, the oscillation frequency of the reference oscillator (reference oscillation frequency) is converted to the atmospheric pressure, and is used as the atmospheric pressure reference value. Further, using the frequency drift calculated on the basis of the phase difference, the amount of atmospheric pressure change is estimated from the atmospheric pressure reference value. Further, the atmospheric pressure change amount is added to the atmospheric pressure reference value to thereby estimate the atmospheric pressure.

### 6-4. Determination of Frequency Stability

In the above-described embodiment, the stability of the crystal oscillation frequency is determined using the Allan variance, but the determination method of the frequency stability is not limited thereto. The Allan variance is two-sample variance, but for example, the variance value may be calculated using more than two samples of the frequency deviation, and the frequency stability may be determined on the basis of the variance value. Any determination method of the frequency stability capable of being applied to the calibration of the estimation time interval may be used.

### 6-5. Other Application Examples

In the above-described embodiment, the Costas loop which is formed by the first loop sequentially including the first multiplier 40, the phase comparing section 11, the loop filter processing section 13, the reference oscillator 30, and the first multiplier 40; and the second loop sequentially including the second multiplier 60, the phase comparing section 11, the loop filter processing section 13, the reference oscillator 30, the delay circuit 50, and the second multiplier 60 is applied to the quartz crystal resonator type atmospheric pressure sensor 1 which is a kind of atmospheric pressure estimation device.

However, the device to which the Costas loop can be applied is not limited to an atmospheric pressure estimation device. For example, the Costas loop may be applied to a position calculation device which performs position calculation using a satellite positioning system. Thus, an application example in which the Costas loop is applied to a GPS position calculation device which performs position calculation using the GPS (Global Positioning System) which is a kind of satellite positioning system will be described. The same reference numerals are given to the same components as the quartz crystal resonator type atmospheric pressure sensor 1 described with reference to FIG. 1, and repetitive description thereof will be omitted.

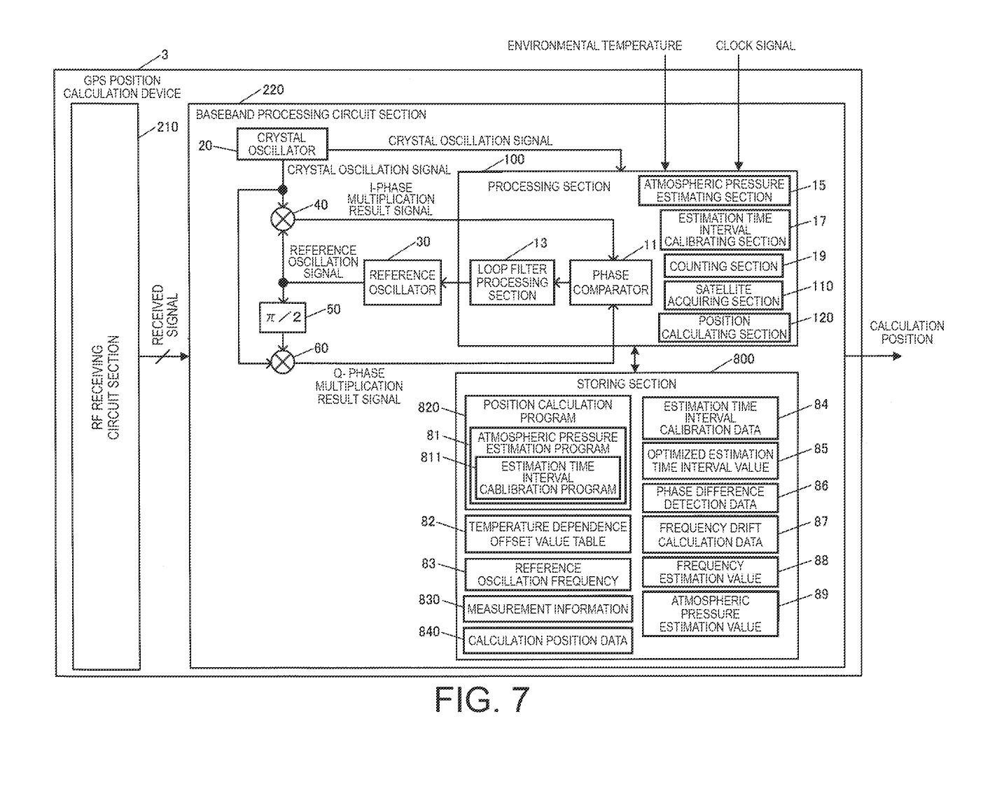

FIG. 7 is a diagram illustrating an example of a functional configuration of a GPS position calculation device 3. The GPS position calculation device 3 includes an RF (Radio Frequency) receiving circuit section 210 and a baseband processing circuit section 220. The RF receiving circuit section 210 and the baseband processing circuit section 220 may be manufactured as different LSIs (Large Scale Integration), or may be manufactured as one chip.

The RF receiving circuit section 210 is a receiving circuit which processes an RF signal received through a GPS antenna (not shown). The RF receiving circuit section 210 may be a receiving circuit which converts the received RF signal into a digital signal by an A/D converter to process the digital signal. Further, The RF receiving circuit section 210 may process the RF signal received through the GPS antenna as an analog signal as it is, may A-D convert the result finally, and may output the digital signal to the baseband processing circuit section 220.

The baseband processing circuit section 220 is a circuit section which acquires a GPS satellite signal transmitted from the GPS satellite on the basis of the received signal output from the RF receiving circuit section 210. The GPS satellite signal is a signal of 1.57542 [GHz] which is modulated by a CDMA (Code Division Multiple Access) system known as a spectrum spread system, by a C/A (Coarse and Acquisition) code which is a kind of spread code. The C/A code is a pseudo random noise code of a repetition cycle of 1 ms using a chip of a code length of 1023 as one PN frame, and is a unique code of each GPS satellite.

The baseband processing circuit section 220 acquires the GPS satellite signal by performing removal of a carrier or a correlation operation for the received signal by means of hardware by a dedicated circuit or by means of software as digital signal processing. Further, using satellite orbit information, time information or the like extracted from the acquired GPS satellite signal, the position (position coordinate) or clock bias of the GPS position calculation device 3 is calculated.

The baseband processing circuit section 220 includes a crystal oscillator 20, a reference oscillator 30, a first multiplier 40, a delay circuit 50, a second multiplier 60, a processing section 100, and a storing section 800, for example.

The processing section 100 includes a processor such as a CPU which is a control device which generally controls the respective functional sections of the baseband processing circuit section 220 and an arithmetic device. The processing section 100 includes an atmospheric pressure estimating section 15, an estimation time interval calibrating section 17, a counting section 19, a satellite acquiring section 110, and a position calculating section 120 as functional sections, for example.

The satellite acquiring section 110 performs digital signal processing such as carrier removal or correlation operation for a received digitalized signal output from the RF receiving circuit section 210. Further, on the basis of the result of the digital signal processing, measurement information 830 (code phase, Doppler frequency, pseudo distance, pseudo distance change rate or the like) relating to a GPS satellite, which is an acquisition target, is calculated.

The position calculating section 120 performs a predetermined position calculation using the measurement information 830 calculated by the satellite acquiring section 110 and an atmospheric pressure estimation value 89 estimated by the atmospheric pressure estimating section 15, to calculate the position and clock bias of the GPS position calculation device 3.

Specifically, the position calculating section 120 performs a three-dimensional position calculation using the measurement information 830, for example, to calculate the three-dimensional position indicated by latitude, longitude and altitude thereof. Further, the position calculating section 120 corrects a position component in altitude using the atmospheric pressure estimating value 89, to calculate a final position. Alternatively, the position calculating section 120 performs a second-dimensional position calculation using the measurement information 830, to calculate a second-dimensional position indicated by latitude and longitude. Further, the position calculating section 120 may calculate the three-dimensional position including the altitude calculated from the atmospheric pressure estimating section 89 as the position of the GPS position calculation device 3.

A position calculation program 820 which is executed in the position calculation process by the position calculating section 120, for example, is stored in the storing section 800, as a program. The position calculation program 820 includes an atmospheric pressure estimation program 81 which is executed in the atmospheric pressure estimation process (see FIG. 5) as a sub-routine. Further, the atmospheric pressure estimation program 81 includes an estimation time interval calibration program 811 which is executed in the estimation time interval calibration process (see FIG. 6) as a sub-routine.

Further, a temperature dependence offset value table 82, a reference oscillation frequency 83, estimation time interval calibration data 84, an optimized estimation time interval value 85, phase difference detection data 86, frequency drift calculation data 87, a frequency estimation value 88, an atmospheric pressure estimation value 89, measurement information 830, and calculation position data 840 are stored in the storing section 800, as data, for example.

The GPS position calculation device 3 in FIG. 7 may be mounted to a variety of electronic devices such as a mobile phone, a car navigation device, a portable navigation device, a personal computer, a PDA (Personal Digital Assistant), a digital camera or a wrist watch.

Further, an applicable satellite positioning system in this case is not limited to the GPS, and a satellite positioning system such as a WAAS (Wide Area Augmentation System), QZSS (Quasi Zenith Satellite System), GLONASS (Global Navigation Satellite System), GALILEO or the like may be used.

What is claimed is:

1. An atmospheric pressure estimation method comprising:
controlling an oscillation frequency of a predetermined oscillator to match the oscillation frequency of the predetermined oscillator to an oscillation frequency of an atmospheric pressure measurement oscillator;
detecting a phase difference between an oscillation signal of the predetermined oscillator and an oscillation signal of the atmospheric pressure measurement oscillator; and
estimating atmospheric pressure using the oscillation frequency of the predetermined oscillator and the phase difference.

2. The method according to claim 1,
wherein the controlling includes controlling the oscillation frequency of the predetermined oscillator on the basis of the phase difference.

3. The method according to claim 1,
wherein the detecting includes detecting the phase difference using a Costas loop.

4. The method according to claim 1,
wherein the estimating includes:
estimating the atmospheric pressure at a first resolution using the oscillation frequency of the predetermined oscillator and
estimating the atmospheric pressure corresponding to 1 Hz or less of the predetermined oscillator at a second resolution higher than the first resolution, using the phase difference.

5. The method according to claim 1,
wherein the estimating includes estimating the atmospheric pressure using the phase difference detected for a predetermined time, and
the method further comprising:
determining stability of the oscillation frequency of the atmospheric pressure measurement oscillator; and
setting the predetermined time on the basis of the stability.

6. The method according to claim 5,
wherein the determining includes calculating an Allan variance of the oscillation frequency of the atmospheric pressure measurement oscillator.

7. The method according to claim 1,
wherein the estimating includes temperature-compensating the atmospheric pressure on the basis of an environmental temperature.

8. An atmospheric pressure estimation device comprising:
an atmospheric pressure measurement oscillator of which oscillation frequency is changed according to atmospheric pressure;
an oscillator of which oscillation frequency can be changed;
a frequency control section which controls the oscillation frequency of the oscillator to match the oscillation frequency of the oscillator to the oscillation frequency of the atmospheric pressure measurement oscillator;
a phase difference detecting section which detects a phase difference between an oscillation signal of the oscillator and an oscillation signal of the atmospheric pressure measurement oscillator; and
an atmospheric pressure estimating section which estimates atmospheric pressure using the oscillation frequency of the oscillator and the phase difference.
